(19) United States
(12) Patent Application Publication
(10) Pub. No.: US 2018/0184290 A1
(43) Pub. Date: Jun. 28, 2018

(54) Embedded Certificate Method for Strong Authentication and Ease of Use for Wireless IoT Systems

(71) Applicant: Cypress Semiconductor Corporation, San Jose, CA (US)

(72) Inventors: Hui Luo, Marlboro, NJ (US); Hans Van Antwerpen, Mountain View, CA (US)

(73) Assignee: Cypress Semiconductor Corporation, San Jose, CA (US)

(21) Appl. No.: 15/476,758

(22) Filed: Mar. 31, 2017

Related U.S. Application Data
(60) Provisional application No. 62/437,877, filed on Dec. 22, 2016.

(51) Int. Cl. H04W 12/06; H04L 29/06

(52) U.S. Cl. CPC H04W 12/06; H04L 63/166; H04L 63/062; H04W 12/04; H04L 63/0442; H04L 63/0838; H04L 63/101; H04L 63/0823

(57) ABSTRACT

An Internet-of-Things (IoT) device and secure communication and authentication protocol is described for identifying an IoT device and counter party and ensuring that communication between the IoT device and the counter party is authenticated before transmission and receipt of data over the trusted communication pathway.

### RELATED APPLICATIONS

This patent application claims the benefit of U.S. Provisional Patent Application No. 62/437,877, filed Dec. 22, 2016, which is incorporated by reference herein in its entirety.

### TECHNICAL FIELD

The present disclosure relates generally to wireless systems, and more particularly connectivity of Internet-of-Things (“IoT”) devices.

### BACKGROUND

Internet-enabled devices and internet connectivity are becoming more and more ubiquitous. As connectivity spreads to more and more devices and the applications of that connectivity increase, the security of information and the communication of that information becomes increasingly important. The internet is no longer confined to personal computers or laptops. Rather, it follows users around in their pocket, in their car, and is present in every corner of their lives. The Internet of Things (IoT) introduces new security challenges as the points of access for malicious software and those seeking private information increases with the presence of ever more devices.

Wireless standards, such as Bluetooth®, Bluetooth Low Energy (BLE), Zigbee®, and WiFi have defined authentication and encryption protocols with strong security performance. However standards-based IoT products may still be vulnerable to security attacks. Many standards use a shared secret as an authentication credential, but a lack of a display or an input/output interface (as IoT technology expands away from merely being present on handsets) creates difficulties in the setup, update, and verification of authentication credentials such as a password or a secret key. Manufactures may use a present or default password or key in IoT devices; users often never change it.

### DESCRIPTION OF THE DRAWINGS

FIG. 1 illustrates a system with an IoT device and communication, according to one embodiment.

FIG. 2 illustrates an embedded certificate, according to one embodiment.

FIG. 3 illustrates an authentication protocol for an IoT device and a counter party, according to one embodiment.

FIG. 4 illustrates a method for establishing an encrypted connection, according to one embodiment.

FIG. 5A illustrates a method for verifying a chip vendor's certificate, according to one embodiment.

FIG. 5B illustrates a method for verifying an IoT chip's certificate, according to one embodiment.

FIG. 6 illustrates an initialization process for authentication of an IoT chip and a counter party, according to one embodiment.

FIG. 7 illustrates an authentication process for an IoT chip and a counter party, according to one embodiment.

FIG. 8 illustrates a process for introduction of a second counter party, according to one embodiment.

FIG. 9 illustrates a method for removal of a counter party from an IoT access control list, according to one embodiment.

FIG. 10A illustrates a method for issuing a certificate from an online source to a device with trusted execution environment, according to one embodiment.

FIG. 10B illustrates a method for generating by a device with trusted execution environment and register the certificate to an online source, according to one embodiment.

FIG. 10C illustrates a method for issuing a certificate from an online source to a device without trusted execution environment, according to one embodiment.

FIG. 11A illustrates a method for providing certificates from a chip vendor at the instruction of a device maker, according to one embodiment.

FIG. 11B illustrates a method sending a device maker's information over a transport layer security (TLS) handshake, according to one embodiment.

FIG. 11C illustrates a method for issuing a certificate over a TLS after verifying valid device firmware, according to one embodiment.

FIG. 12 illustrates a method of providing a Bluetooth® lock with strong security according to the described protocol, according to one embodiment.

### DETAILED DESCRIPTION

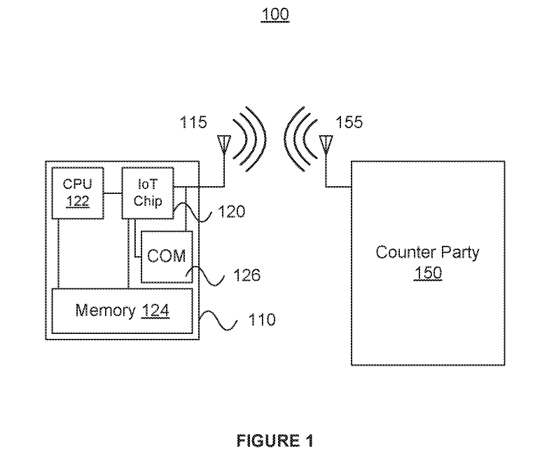

FIG. 1 illustrates a system 100 comprising an device 110 equipped with a wireless radio and antenna 125 and a counter party 150 that is also equipped with a wireless radio and antenna 155. Device 110 may be an IoT chip 120 that is coupled to antenna 115 and to a processing unit (CPU) 122. IoT chip 120 and CPU 122 may also be coupled to a memory 124. Memory 124 may store data or programs that are accessed and/or executed by IoT chip 120 and/or CPU 122. IoT chip (also referred to as IoT device) 120 may communicate wirelessly to and with counter party 150 through antennae 115 and 155 according to the various protocols described herein. In one embodiment, a separate COM circuit 126 may be included in device 110, while in another, the COM circuit 126 may be included in IoT chip 120. Counter party 150 may be a mobile handset, or another computing device. Counter party 150 may also be an integrated circuit disposed within the same complete device as the IoT chip.

IoT chip 120 may use an embedded certificate which, coupled with a set of protocols for issuing the certificate, allows the IoT chip to identify itself and validate secure communication and control. Embedded certificates may be issued during manufacturing or programming. In other embodiments, certificates may be issued online by chip vendors or other third parties which may be enabled by chip vendors. The set of protocols may include initialization, introduction, authentication, and removal protocols. These protocols may build, prove, and manage trust relationships between devices, such as IoT chip 120 and counter party 150.

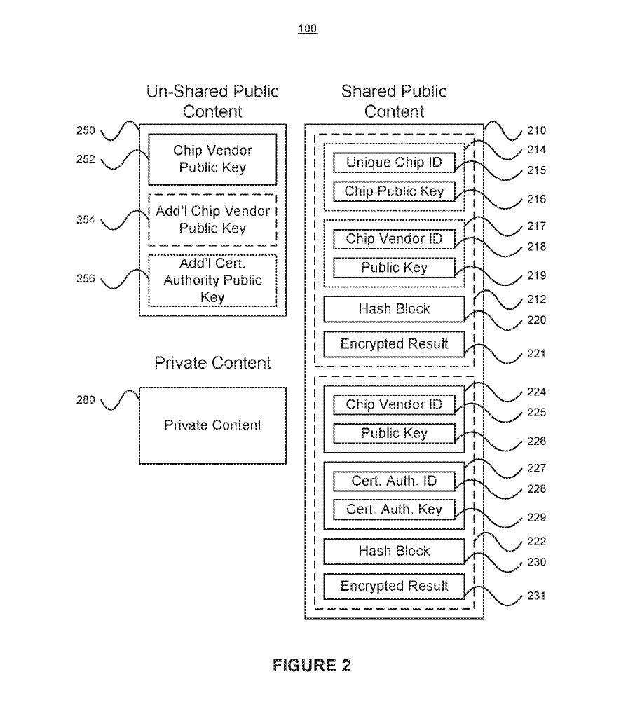

FIG. 2 illustrates an embodiment of an embedded certificate 200. Embedded certificate 200 may include shared public content 210 and unshared public content 250. Shared public content 210 may be a two-certificate chain or a single certificate. For single-certificate shared public content, a first certificate 212 may be assigned a chip vendor's private key and include chip identification information 214, including a unique chip ID 215 and a chip public key 216. In one embodiment, the unique chip ID 215 is not a root key supplied by the vendor, but rather a specific ID provided to the chip. First certificate 212 may also include chip vendor information 217, including the chip vendor ID 218 and the chip vendor public key 219. In one embodiment, first certificate 212 may include a pre-installed root key (not pictured) supplied by the vendor or by a vendor for in-system programming. The pre-installed root key may therefore be provided by a trusted supplier or programming vendor. The IDs and the public keys of the chip and the chip vendor may be converted to a hash and stored in a hash block 220. Finally, hash block 220 and the chip vendor's private key (not shown) may be used to generate and store an encrypted result 221.

For two-certificate chains, a second certificate 222 may be added to certificate 212. Second certificate 222 may include second chip vendor information 224, including the chip vendor ID 225 and the chip vendor public key 226. Second certificate 222 may also include certificate authority information 227, including the certificate authority's ID 228 and the certificate authority's public key 229. The IDs and the public keys chip vendor and the certificate authority may be converted to a hash and stored in a hash block 230. Finally, hash block 230 and the certificate authority's private key (not shown) may be used to generate and store an encrypted result 231.

Unshared public content 250 of embedded certificate 200 may include the chip vendor's public key 252 as well as public keys of other chip vendors 254 and certificate authorities 256. The number of public keys may be determined by the size of the storage into which embedded certificate 200 is saved. Public keys for chip vendors that are not the chip vendor of chip vendor public key 252 and certificate authorities may be obtained online.

Embedded certificate 200 may include private content 280, including a private key for the chip. In such embodiments, security protocols may need to be implemented to protect private content.

Information contained in embedded certificate 200 may be fixed (not alterable). In various embodiments, information of embedded certificate may be stored in on-time programmable (OTP) registers or in protected internal memory, such as flash. Embedded certificate 200 may be issued to an IoT chip online at a time after manufacturing, for low-cost manufacturing and optional use of certificate-based security functions, by the chip vendor's server or by a device maker's server assisted by the chip vendor. If the embedded certificate is issued by the chip vendor's server, the device firmware may be verified to ensure that it is not compromised to prevent a certificate from being issued to a malicious device using a genuine IoT chip.

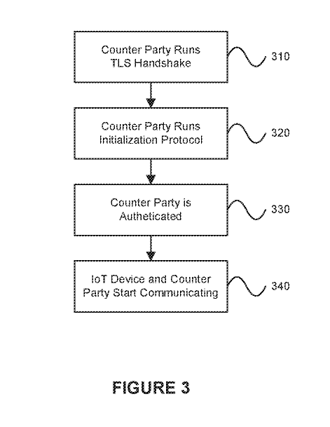

An embedded certificate may be verified by a counter party with or without internet connectivity. FIG. 3 illustrates a high-level process 300 for identifying, authenticating, and communicating between IoT devices and counter parties, according to one embodiment. A counter party may first run a transport layer security (TLS) handshake in step 310 to establish a secure connection. The TLS handshake protocol may use a public/private key algorithm to authenticate the chip based on its chip ID. The TLS handshake protocol may then create an encrypted connection for the remainder of high-level process 300. After the TLS handshake is complete, the counter party may run an initialization protocol in step 320. Initialization protocol may be used to build a trust relationship between the counter party and the IoT device over the encrypted TLS connection from step 310. The trust relationship may be created by supplying a high-entropy shared secret or a certificate. The counter party may then be authenticated by a device with the embedded certificate in step 330. The counter party may be authenticated by showing that it knows the high-entropy shared secret or the provided key corresponding to its certificate. Once the counter party is authenticated the counter party and the IoT device may begin communicating in step 340. Communication of step 340 may be for all purposes, including introducing or removing other counter parties to and from the IoT device for trusted communications.

High-level process 300 may be referred to as a certificate-based security protocol and may be started with an IoT chip validating device firmware to prevent a certificate from being used by a compromised device. The certificate-based security protocol may require frequent updates to the certificate from a server due to short expiration times of previously issued certificates. In this embodiment, it may be more difficult to compromise a device with an issued certificate.

The certificate-based security protocol may provide strong authentication based on a chip-specific ID. It may remove the requirement to setup, input, and verify shared secrets as authentication credentials. And, finally, it may provide better ease-of-use for IoT devices.

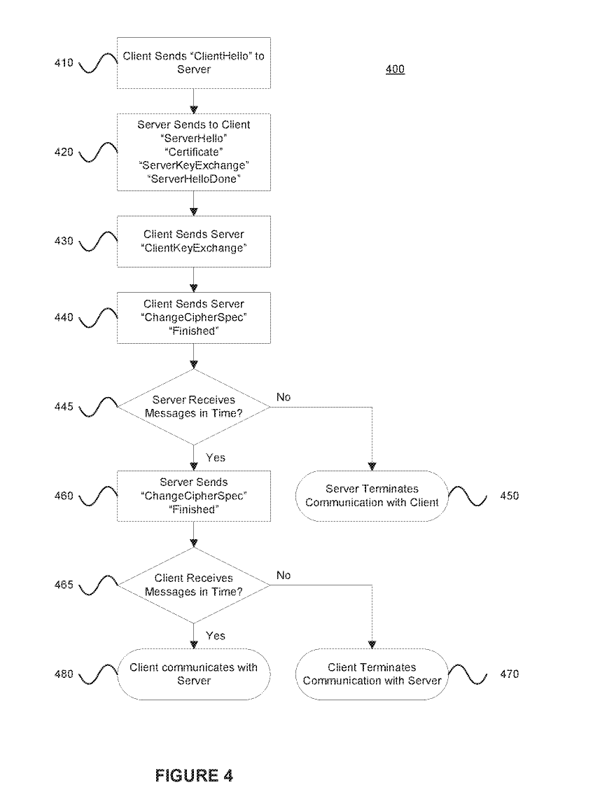

High-level process 300 begins with the counter party running a TLS handshake in step 310. FIG. 4 illustrates a flowchart of TLS handshake 400, according to an embodiment. First, the counter party (also referred to as a “client”) sends a “ClientHello” message to the IoT chip (also referred to as a “server”) in step 410. The IoT chip then responds to the counter party by sending several messages, including: “ServerHello,” “Certificate,” “ServerKeyExchange,” and “ServerHelloDone” in step 420. The counter party sends a “ClientKeyExchange” message to the IoT chip in step 430 and the sends “ChangeCipherSpec” and “Finished” messages in step 440. If the IoT chip does not receive the above messages from the counter party in time in step 445, the IoT device terminates communication with the counter party in step 450. If the IoT device does receive the above messages from the counter party in time in step 445, the IoT chip sends “ChangeCipherSpec” and “Finished” messages to the counter party in step 460. If the counter party does not receive the above messages from the IoT chip in time in step 465, the counter party terminates communication with the IoT device in step 470. If the counter party does receive the above messages from the IoT chip in time in step 465, the handshake is completed and further initialization and authorization, as discussed above with regard to FIG. 3, may be completed in step 480.

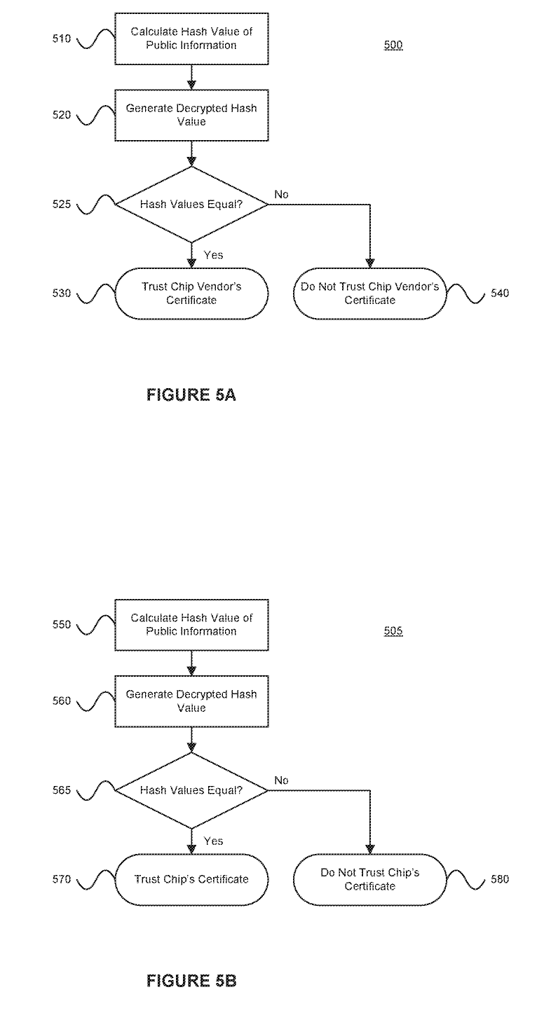

The TLS handshake 400 of FIG. 4 may be used to verify the chip vendor's certificate and/or the IoT chip's certificate. The TLS handshake 400 may verify the chip vendor's certificate according to a method 500 of FIG. 5A. First, the counter party may calculate a hash value from public information (according to FIG. 2, above) in step 510. A decrypted hash value may then be created in step 520. If the calculated hash value and the decrypted hash value are the same in step 525, the chip vendor's certificate may be trusted and the remainder of the TLS handshake of FIG. 4 and the communication of FIG. 3 may proceed in step 530. If the calculated hash value and the decrypted hash value are not the same in step 525, the chip vendor's certificate may not be trusted and communication between the counter party and the IoT chip may be terminated in step 540.

As stated above, the TLS handshake 400 may verify the IoT chip's certificate according to a method 505 of FIG. 5B. First, the counter party may calculate a hash value from public information (according to FIG. 2, above) in step 550. A decrypted hash value may then be created in step 560. If the calculated hash value and the decrypted hash value are the same in step 565, the chip's certificate may be trusted and the remainder of the TLS handshake of FIG. 4 and the communication of FIG. 3 may proceed in step 570. If the calculated hash value and the decrypted hash value are not the same in step 565, the chip's certificate may not be trusted and communication between the counter party and the IoT chip may be terminated in step 580.

After the TLS handshake is completed and an encrypted connection is created, the IoT chip may be authenticated to the counter party. For example, the IoT chip demonstrates that it owns the private key corresponding to the claimed unique chip ID. However, the counter party has not been authenticated to the IoT chip. In instances where the counter party does not have the IoT chip's ID in its access control list (ACL), meaning that it has not had a trust relationship with the IoT device (or IoT chip), an initialization process may be executed to set up the trust relationship.

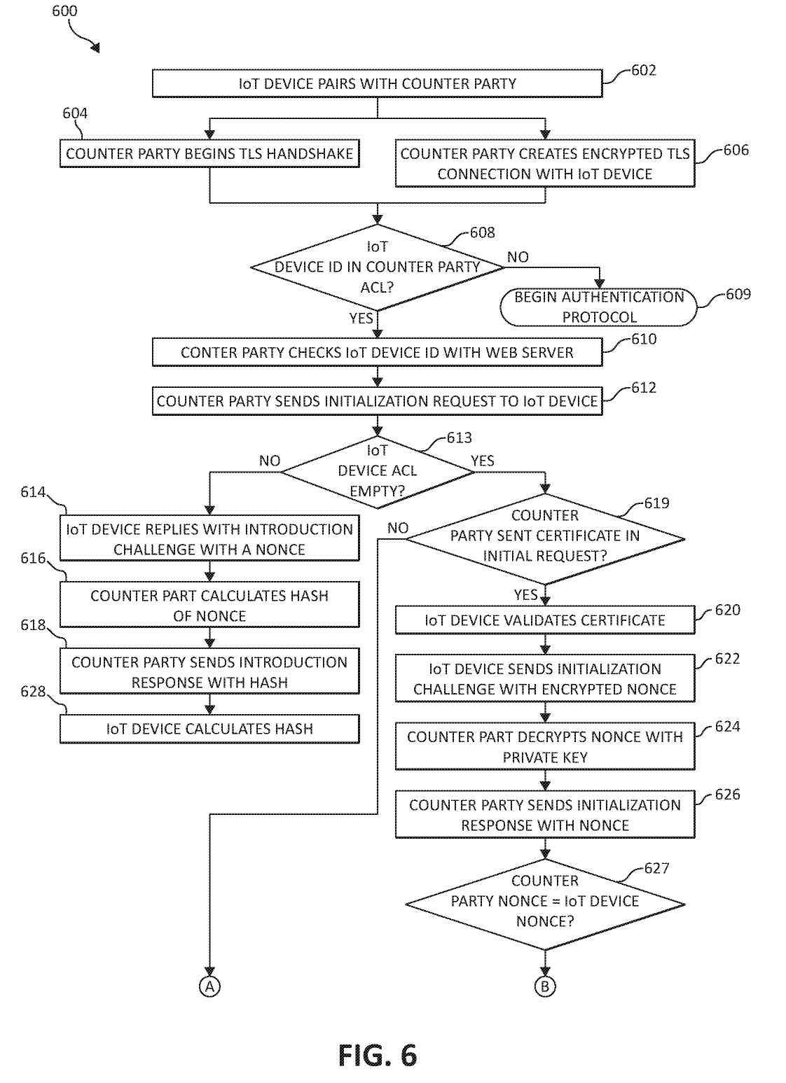

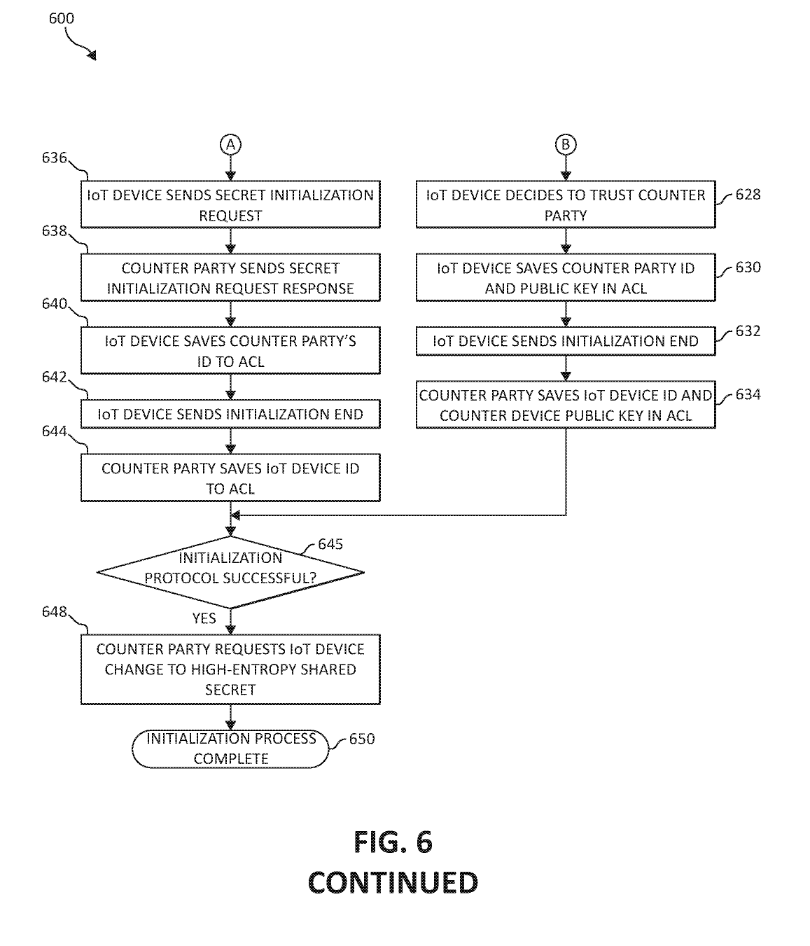

FIG. 6 illustrates one embodiment of an initialization process 600 to create the trust relationship between the IoT device (or IoT chip) and the counter party. First, the IoT device pairs with the counter party in step 602 using a shared secret. The shared secret may be potentially weak and is created only for the initial step of pairing the two devices for the subsequent initialization and authorization. The counter party then begins a TLS handshake in step 604 and creates an encrypted TLS connection with the IoT device in step 606 (as described above with regard to FIG. 4).

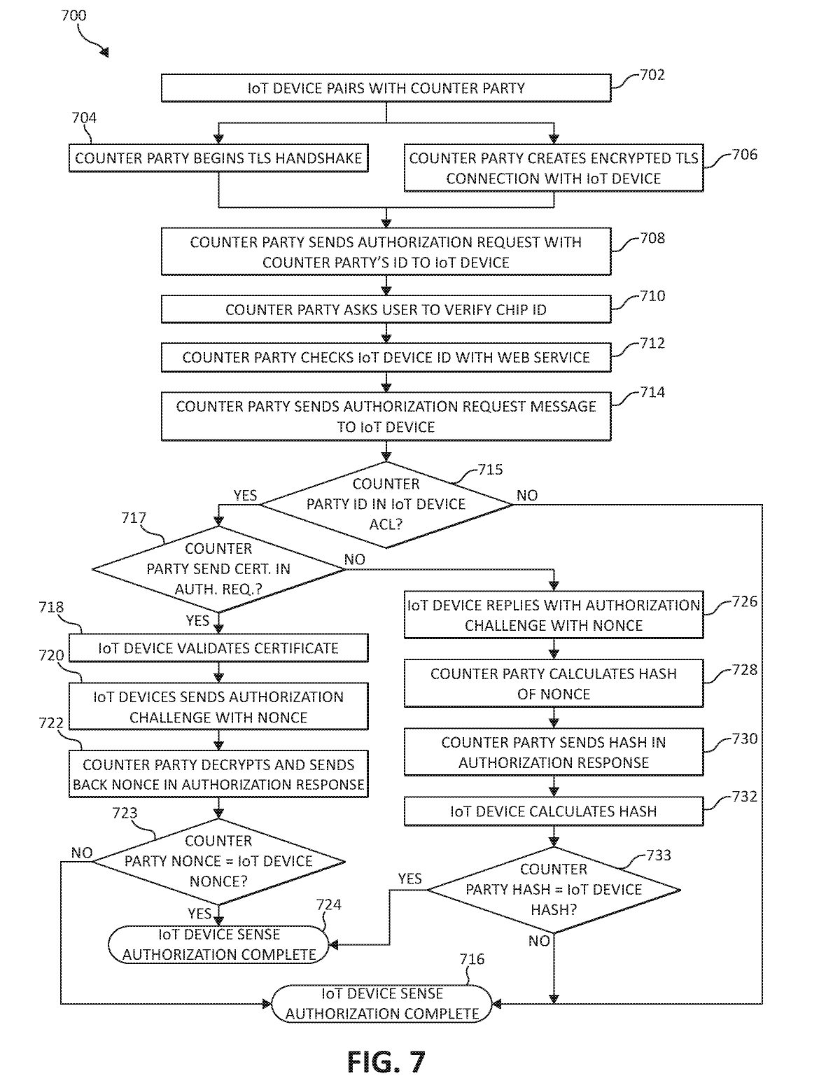

If the IoT device's ID is in the counter party's ACL in step 607, initialization process 600 is no longer required and the protocol may proceed to the authentication protocol in step 608 (discussed in more detail in FIG. 7). If the IoT device's ID is not in the counter party's ACL, the counter party may check the IoT device's ID with a web server or online database of the manufacturer of the device containing the IoT device to ensure that the device is actually made by the manufacturer and not compromised in step 610. In one embodiment, step 610 may be deferred to a time when internet connectivity is available to the counter party. In another embodiment, the counter party may request a user to verify a chip ID that may be printed on the device containing the IoT device is identical to the ID that is presented in the IoT devices certificate. If they are identical, the initialization process may continue.

The counter party device may then send an Initialization Request, comprising the counter party's ID or certificate, to the IoT device in step 612. If the IoT device's ACL is not empty in step 613 and the counter party's ID is not in the IoT device's ACL but in a pending ACL, the IoT device may respond to the Initialization Request with an Introduction Challenge with a nonce in step 614. The counter party may then calculate a hash value of the nonce with the manufacturer's low-entropy key (stored in the pending ACL with the counter party's ID) in step 616. The counter party may then send an Introduction Response with the hash in step 618. The IoT device may then calculate the same hash and ensure the two hashes (from the counter party and from the IoT device) match in step 620.

If the two hashes match or if the IoT device's ACL is empty in step 613, initialization process 600 determines if the counter party sent a certificate in the Initialization Request in step 619. If the counter party sent a certificate in the Initialization Request, the IoT device validates the certificate in step 620 and sends an Initialization Challenge with an encrypted nonce in step 622. In one embodiment, the encrypted none of step 622 is derived from the counter party's public key. The counter party may decrypt the nonce with its private key in step 624 and sends an Initialization Response with the decrypted nonce in step 626. If the counter party's nonce and the IoT device's nonce match in step 627, the IoT device may decide to trust the counter party in step 628. The IoT device may then save the counter party's ID and public key in its ACL in step 630 and send an Initialization End message in step 632. The counter party may save the IoT device's ID and the counter party's public key to its ACL in step 634.

If the counter party did not send a certificate in the Initialization Request in step 619, the IoT device sends a secret Initialization Request in step 636 and the counter party sends a secret Initialization Request response with a high-entropy secret and a low-entropy password in step 638. The IoT device then saves the counter party's ID to its ACL in step 640 and sends back an Initialization End message in step 642. The counter party then saves the IoT device's ID and the high-entropy secret to its ACL in step 644. In one embodiment, the high-entropy secret that is saved to the counter party's ACL may be encrypted using a user-generated key.

From steps 634 and 644, wherein the counter party saves the IoT device's ID to its ACL (as well as the counter party's public key in step 634), initialization process determines if the initialization protocol has been successful in step 645. If it has, the counter party requests that the IoT device change to a high-entropy shared secret in step 648 and the entire authentication process (of which the Initialization process 600 is part) is complete in step 650. The IoT device and the counter party may then communicate over a hardware encryption connection based on a shared secret or over the TLS connection, which may not be supported by hardware. If the initialization protocol has not been successful in step 645 the IoT device may send back and Initialization Reject message and communication between the IoT device and the counter party may be terminated.

If, in step 607 of Initialization Process 600 the IoT device's ID is in the counter party's ACL, the authorization protocol may be started in step 608. FIG. 7 illustrates one embodiment of the authentication protocol 700 that is references in step 608 of FIG. 6. Authentication protocol 700 may be executed when there is already a trust relationship between the IoT device and the counter party. Authorization protocol 700 is therefore used to authenticate the counter party to the IoT device.

Authentication protocol 700 begins with the IoT device pairing with the counter party in step 702. The counter party may then begin the TLS handshake in step 704 and create an encrypted TLS connection with the IoT device in step 706. The counter party may then send an Authentication Request with the counter party's ID to the IoT device in step 708. The counter party may check the IoT device's ID with a web server or online database of the manufacturer of the device containing the IoT device to ensure that the device is actually made by the manufacturer and not compromised in step 710. Step 710 may be deferred until the counter party has internet connectivity. In another embodiment, the counter party may request a user to verify a chip ID that may be printed on the device containing the IoT device is identical to the ID that is presented in the IoT devices certificate in step 712. If they are identical, the authentication process may continue.

The counter party may then send an Authentication Request message to the IoT device in step 714. If the counter party's ID is not in the IoT device's ACL in step 715, the IoT device may send an Authentication Reject message and terminate communication with the counter party in step 716.

If the counter party's ID is in the IoT device's ACL in step 715 and if the counter party sent a certificate in the Authentication Request in step 717, the IoT device may validate the certificate in 718. The IoT device may then send an Authentication Challenge with a nonce encrypted using the counter party's public key in step 720. The counter party may then decrypt the nonce from the IoT device using the private key and sends back the nonce in the Authentication Response in step 722. If the counter party nonce is the same as the IoT device nonce in step 723, the IoT device may send an Authentication Complete message in step 724. If the counter party nonce is not the same as the IoT device nonce in step 723, the IoT device may send an Authentication Reject message and terminate communication with the counter party in step 716.

If the counter party's ID is in the IoT device's ACL in step 715 and if the counter party did not send a certificate in the Authentication Request in step 717, the IoT device may reply with an Authentication Challenge comprising a nonce in step 726. The counter party may calculate the hash of the nonce with the counter party's high-entropy secret in step 728 and send back the hash in an Authentication Response in step 730. The IoT device may then calculate the same hash using the counter party's high-entropy secret is stored in the IoT device's ACL with the counter party's ID in step 732. If the hash from the counter party and the hash calculated by the IoT device are the same in step 733, the IoT device may send back an Authentication Complete message in step 724. If they do not match, the IoT device may send back an Authentication Reject message in step and terminate communication with the counter party in step 716.

Once the authentication process of FIG. 7 is complete and successful, the IoT device may communicate with the counter party over a hardware encryption connection based on shared secret or over the TLS connection, which may or may not be supported by hardware.

Once the entire authentication process of FIG. 7 is complete and successful, if the IoT device is permitted to maintain trust relationships with more than one counter party, a counter party that is already on the IoT chip's ACL may introduce another counter party to enter a trust relationship with the IoT chip through an introduction process.

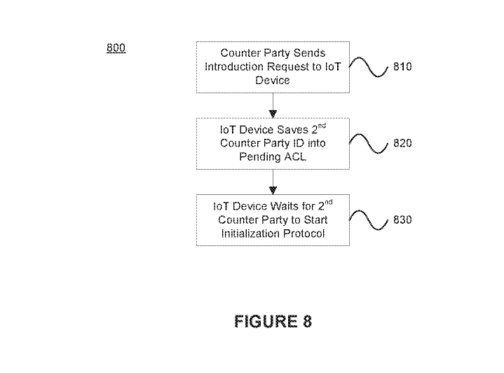

FIG. 8 illustrates one embodiment of an introduction process 800. A counter party that is already on the IoT device's ACL may send an Introduction Request to the IoT device in step 810. The IoT device may then save the send counter party ID into a pending ACL in step 820 and may then wait for the second counter party to initiate and initialization protocol in step 830. In one embodiment, the initialization protocol for the second counter party may be similar to the initialization process 600 of FIG. 6. In still another embodiment, the IoT device may start a timer to provide a window of time during which an initialization request from the second counter party must be received. If the initialization request from the second counter party is not received by the time the timer of the IoT device expires, initialization protocol may not start and a repeated introduction process, according to FIG. 8, may be required.

As counter party may introduce other counter parties to the IoT device, so can counter parties remove other counter parties or themselves from the IoT device's ACL. In one embodiment, the to-be-removed counter party must provide approval according to a removal process.

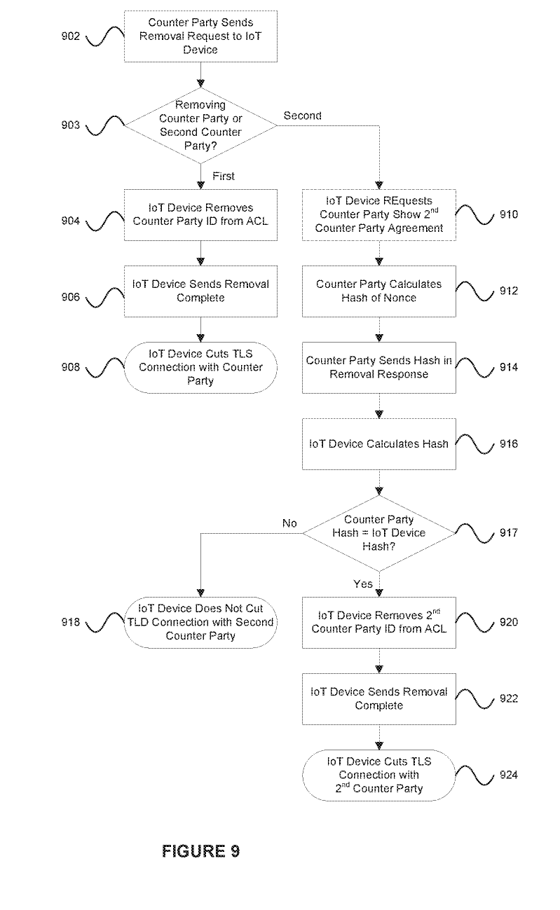

FIG. 9 illustrates a removal process 900 for removal of a second counter party from an IoT device's ACL. First, a counter party sends a Removal Request to the IoT device in step 902. If the counter party is attempting to remove itself from the IoT devices ACL in step 903, the IOT device removes the counter party from its ACL in step 904 and sends a Removal Complete message in step 906. The IoT device may then sever the TLS connection with the counter party in step 908.

If the counter party is attempting to remove another (second) counter party from the IoT devices ACL in step 903, the IOT device may optionally request that the counter party demonstrate agreement by the second counter party in step 910. The counter party may then calculate a hash of the nonce with the second counter party's low-entropy password in step 912 and send the hash to the IoT device in a Removal Response in step 914. The IoT device may then calculate the same hash in step 916. If the hashes calculated by the first counter party and the IoT device do not match in step 917, the IoT device does not sever the TLS connection with the second counter party in step 918. If the hashes calculated by the first counter party and the IoT device do match in step 917, The IoT device removes the second counter party ID from its ACL in step 920, sends a Removal Complete message in step 922, and severs the TLS connection with the second counter party in step 924.

Embedded certificates may be programmed directly into an IoT chip during the chip manufacturing and test process. As stated above, the embedded certificate may be stored in OTP registers or in a protected internal memory. In another embodiment, an embedded certificate may be issued to an IoT chip after the IoT chip has been built into a device that uses the above described protocol. In this embodiment, the embedded certificate may be issued from an online source. The issuance of an embedded certificate after the device is fully (or partially) assembled may provide a number of benefits. The lack of chip-specific information or secrets in IoT chips may allow the final device to be assembled at low-cost factories that do not satisfy more robust security requirements. This may lower total manufacturing costs. IoT chips without embedded certificates, but with chip-specific secrets may be prevented from being put to malicious ends by putting them into devices that are not trustworthy. Finally, chips without specific embedded certificates may be used across a wide variety of products with different security requirements, and the security requirements may be implemented post-production.

Device firmware may be stored in a memory (similar to memory 124) or may be located inside the IoT chip in the IoT chip's memory. The device firmware may be programmed with the IoT firmware in the factory during production and test. In one embodiment, every IoT chip may be flashed (programmed) with the same firmware image without any chip-specific secrets. In this embodiment, if the IoT chip does not have an embedded certificate (one was not provided by the chip vendor or manufacturer), the device firmware may trigger the IoT device to request a certificate from an online source. The device firmware may ensure internet connectivity between the IoT chip and the device maker's server. The certificate may be issued from an online source after the device firmware is confirmed as valid.

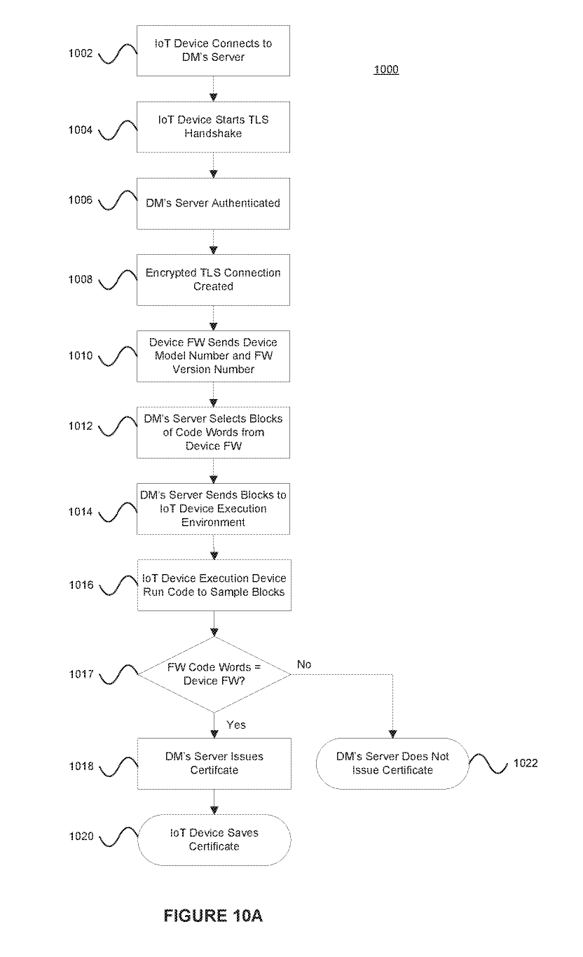

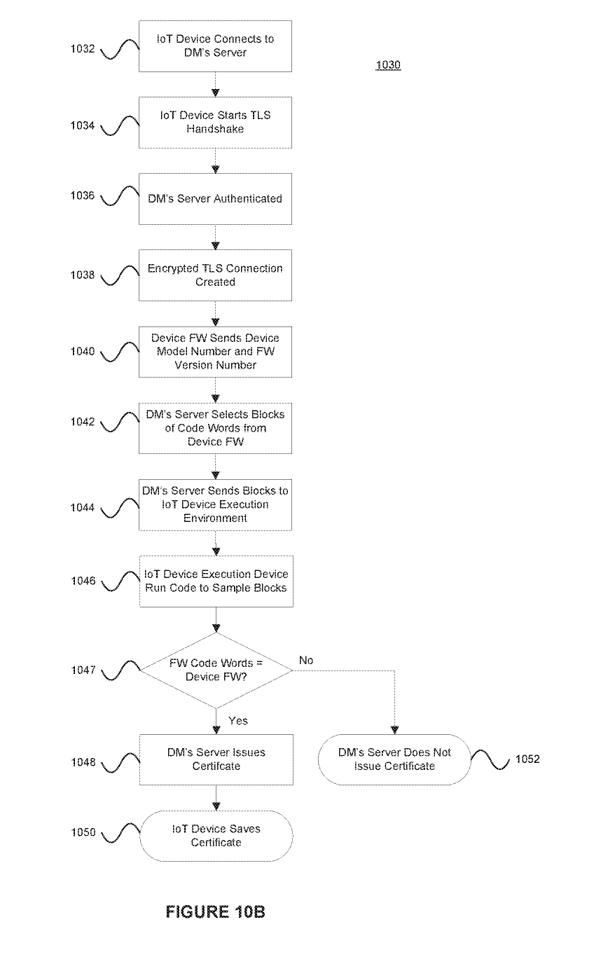

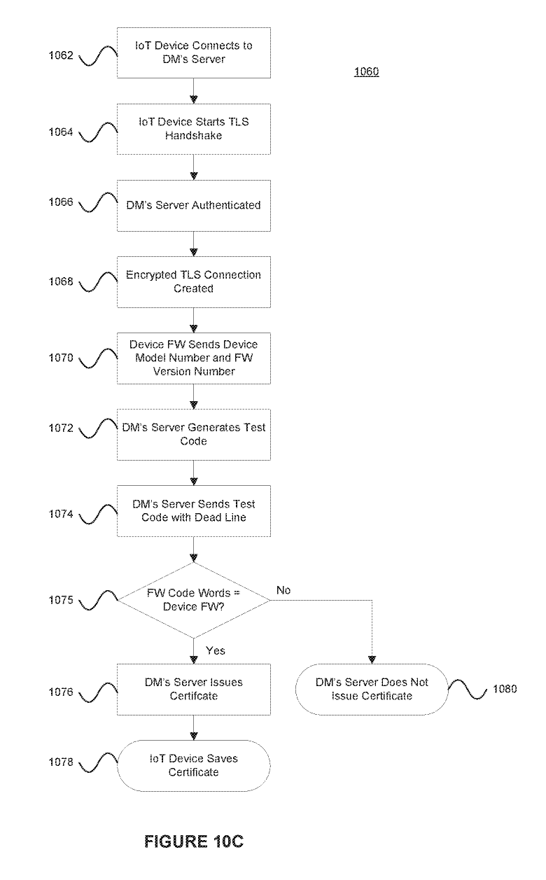

FIG. 10A illustrates a method 1000 for issuing a certificate to an IoT chip in a device with a trusted execution environment for the IoT chip from an online source. The IoT device (also referred to as IoT chip) first connects to the device maker's server in step 1002. The device maker may be the manufacturer of a system or partial system into which the IoT device (or IoT chip) may be integrated. The server may be a database that is accessible through a connection. The server may be accessed through the internet, through a local network, through a hard-wired connection, or through some other mechanism. After the IoT chip connects to the device maker's server, the IoT device may begin a TLS handshake in step 1004 similar to the TLS handshake described in FIG. 4. Because the IoT chip is programmed with the device maker's public key, which is built into the firmware, the device maker's server may be authenticated in step 1006 and an encrypted TLS connection is created in step 1008. The device may then send the device model number and the firmware version number from the IoT device to the server in step 1010, after which the device maker's server randomly selects a number of blocks of code words of the device firmware in step 1012. These block numbers are sent to the IoT chip's trusted execution environment in step 1014. The IoT chip's trusted execution environment runs a piece of code to sample the specified blocks of firmware code words and sends hash results back to the device maker's server in step 1016. If the firmware code words match the device firmware in step 1017, the device maker's server validates the device (and the IoT chip) and issues a certificate containing a unique IoT chip ID and a chip-specific public key signed by the device maker's private key, and the corresponding chip-specific private key to the IoT chip in step 1018. The IoT chip then saves the certificate and the chip-specific private key into protected OTP registers (or equivalents) in step 1020 for future uses in authentication. If the firmware code words do not match the device firmware in step 1017, the device maker's server does not issue a certificate in step 1022.

FIG. 10B illustrates a method 1030 for an IoT chip in a trusted execution environment in a device to generate chip ID and a pair of public/private key internally and register the public key to an online source that in turns signs the public key and chip ID into a certificate. The IoT device (also referred to as IoT chip) connects to the device maker's server in step 1032. The server may be a database that is accessible through a connection. The server may be accessed through the internet, through a local network, through a hard-wired connection, or through some other mechanism. The device maker may be the manufacturer of a system or partial system into which the IoT device (or IoT chip) may be integrated. After the IoT chip connects to the device maker's server, the IoT device may begin a TLS handshake in step 1034 similar to the TLS handshake described in FIG. 4. Because the IoT chip is programmed with the device maker's public key, which is built into the firmware, the device maker's server is authenticated in step 1036 and an encrypted TLS connection is created in step 1038. The device generates a chip ID and a pair of public/private key, then sends the chip ID, the public key, the device model number and the firmware version number from the IoT device to the server in step 1040, after which the device maker's server randomly selects a number of blocks of code words of the device firmware in step 1042. These block numbers are sent to the IoT chip's trusted execution environment in step 1044. The IoT chip's trusted execution environment runs a piece of code to sample the specified blocks of firmware code words and sends hash results back to the device maker's server in step 1046. If the firmware code words match the device firmware in step 1047, the device maker's server validates the device (and the IoT chip) and signs the chip ID and public key into a certificate, and sends the certificate to the IoT chip in step 1048. The IoT chip then saves the certificate and the chip-specific private key into protected OTP registers (or equivalents) in step 1050 for future uses in authentication. If the firmware code words do not match the device firmware in step 1047, the device maker's server does not issue a certificate in step 1052.

FIG. 10C illustrates a method 1060 for issuing a certificate to an IoT chip to a device without trusted execution environment from an online source. The IoT device (also referred to as IoT chip) first connects to the device maker's server in step 1062. The server may be a database that is accessible through a connection. The server may be accessed through the internet, through a local network, through a hard-wired connection, or through some other mechanism. The device maker may be the manufacturer of a system or partial system into which the IoT device (or IoT chip) may be integrated. After the IoT chip connects to the device maker's server, the IoT device may begin a TLS handshake in step 1064 similar to the TLS handshake described in FIG. 4. Because the IoT chip is programmed with the device maker's public key, which is built into the firmware, the device maker's server is authenticated in step 1066 and an encrypted TLS connection is created in step 1068. The device may then send the device model number and the firmware version number from the IoT device to the server in step 1070, after which the device maker's server generates a piece of test code in step 1072. The test code is sent to the IoT chip with a short dead line that covers code execution time and the round trip time for data transmission in step 1074. The test code then samples some firmware code words and sends hash results back to the device maker's server. If the firmware code words match the device firmware in step 1075, the device maker's server validates the device (and the IoT chip) and issues a certificate containing a unique IoT chip ID and a chip-specific public key signed by the device maker's private key, and the corresponding chip-specific private key to the IoT chip in step 1076. The IoT chip then saves the certificate and the chip-specific private key into protected OTP registers (or equivalents) in step 1078 for future uses in authentication. If the firmware code words do not match the device firmware in step 1075, the device maker's server does not issue a certificate in step 1080.

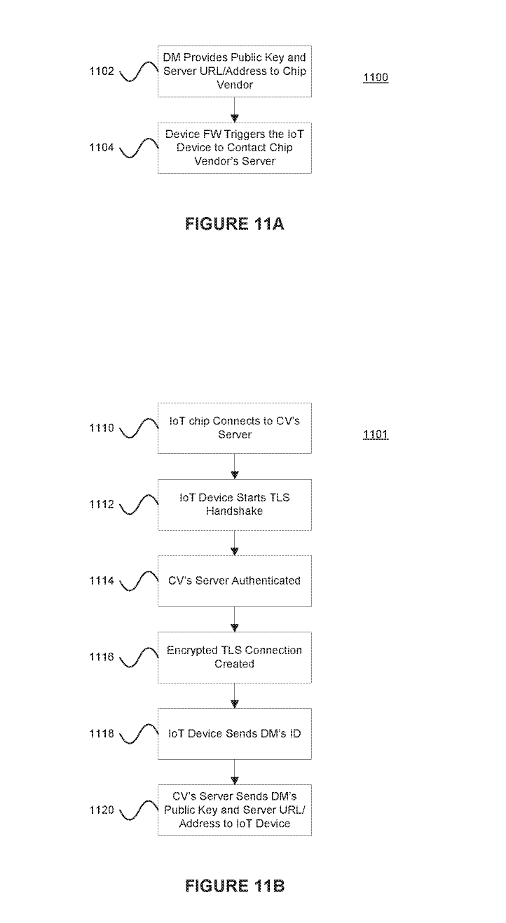

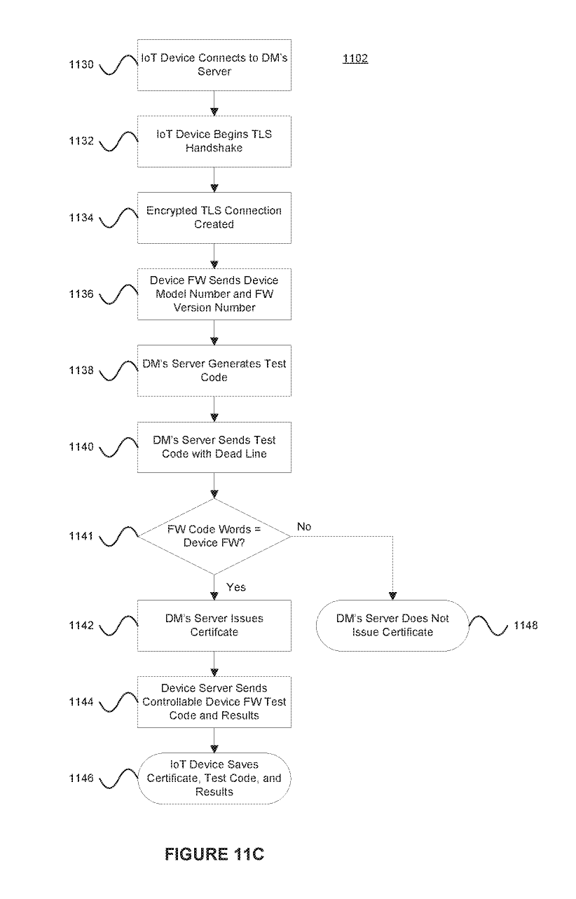

In another embodiment, a device maker may desire that the chip vendor allow itself to issue certificates. FIG. 11A illustrates a method 1100 for a IoT chip receiving a certificate from a chip vendor's server. The device maker may provide a public key and a server URL or address to the chip vendor in step 1102. The device firmware may then trigger the IoT to device to contact the chip vendor's server in step 1104. In this embodiment, after the IoT chip has contacted the chip vendor's server, the process may follow the method 1000 of FIG. 10, wherein the certificate is issued by the device maker's server. However, in this embodiment, the device maker's server is replaced by the chip vendor's server.

Step 1102 of FIG. 11A, wherein the device maker provides its public key and a server URL or address to the chip vendor is further explained in the embodiment of method 1101 of FIG. 11B. The IoT chip may first connect to the chip vendor's server in step 1110, after which the IoT device starts a TLS handshake in step 1112. The TLS handshake may be created similar to that described above with regard to FIG. 4. The chip vendor's certificate may be authenticated in step 1114 because the IoT chip is programmed with the chip vendor's public key. Therefore, an encrypted TLS connection is created in step 1116. The IoT chip may then send the device maker's ID to the chip vendor's server in step 1118. The chip vendor's server may then send the corresponding device maker's public key and server URL or address to the IoT chip in step 1120. The IoT chip then saves the device makers key and server URL or address into OTP registers or equivalents.

After the IoT chip has the necessary information from the chip vendor's server, the device maker may issue a certificate over TLS after verifying the device firmware is valid. An embodiment for the issuance of a certificate over TLS is illustrated as method 1103 of FIG. 11C. The IoT chip may connect to the device maker's server in step 1130 and being a TLS handshake in step 1132, similar to the TLS handshake described above with regard to FIG. 4. The encrypted TLS connection may be created in step 1134. The device maker's server may be authenticated because the IoT chip has the device maker's public key. The device firmware may then send the device model number and the firmware version to the device maker's server in step 1136. The device maker's server may generate a piece of test code with a dead line that cover the code execution time and the round trip time for data transmission in step 1138 and send that code to the IoT device in step 1140. The test code may sample some firmware code words and send the hashed result back to the device maker's server. If the code words match the device firmware in step 1141, the device (and the IoT chip) may be determined non-malicious and the device maker's server may issue a certificate and a chip-specific private key to the IoT chip in step 1142. The certificate and chip-specific private key may include a unique chip ID and a matched public key, signed by the device maker's private key. The device maker's server may also send a piece of controllable device firmware test code and corresponding test results to the IoT chip in step 1144. The IoT chip may then save the certificate, chip-specific private key, test code, and results to OTP registers or equivalents in step 1146. If the code words do not match the device firmware in step 1141, the device (and the IoT chip) may be determined to be malicious or for some other reason the device maker's server may fail to issue a certificate and a chip-specific private key to the IoT chip in step 1148.

In one embodiment, the IoT chip may check the device firmware validity before providing certificate-based service or before transmitting any data. In this embodiment, the IoT chip firmware may randomly generate a piece of test code based on the controllable device firmware test code received from the device maker's server when it issued the certificate in step 1142. The IoT chip may send the code to the device firmware with a short dead line that covers code executing time only. The test code may then sample some firmware code words and send the hashed results back to the IoT chip. The firmware code words match the test results, which is also receive from the device maker's server when it issues the certificate in step 1142, the device is determined to be non-malicious and the IoT chip may continue networking service.

In this embodiment, when a malicious device attempts to defeat the test code and obtains a certificate by fooling the server, the malicious device must analyze the test code and generate a correct answer by studying a copy of the device firmware. The test code is randomly generated with random code words which may include a mixture of useless instructions (such as ADDSUB/MULTIPLY) and useful instructions. The effort to generate the correct answer is defeated by assigning a short timeout value to a timer. This short timeout covers the time required to run the test code and send back the result and does not leave overhead for the malicious device to complete the analysis of the test code and produce the correct answer. A significant amount of time is required by the malicious device to de-assemble and understand the randomly generated binary code. This amount of time is greater than the time provided.

In another embodiment, an expiration time may be added in the issued certificates, which may require the procedure of FIGS. 11A-C be executed to request a new certificate with new expiration time before the current certificate expires. The repetitive nature of the certificate issuing authority creates further barriers to malicious devices.

In various embodiments, the embedded certificate of FIG. 2 and the initialization, authentication, introduction, and removal protocols of FIGS. 3-9 may be used to implement secure communication in Bluetooth® and Bluetooth® Low Energy (BLE) systems, Zigbee networks, or WIFI systems with strong authentication and greater ease-of-use. One or ordinary skill in the art would recognize that the certificate and protocols described above may be used in secure wireless communication standards that are not listed herein.

The above-described solution may be built into firmware of existing Bluetooth ® and BLE and WIFI chips, or built into specific hardware for Bluetooth®, BLE, Zigbee®, and WIFI chips. Building the solution into an IoT system-on-chip (SOC) may follow the architecture described below.

Shared and public content, such as shared public content 210 of FIG. 2, may be saved into read-only OTP registers or equivalent hardware. The first certificate (212 of FIG. 2) may claim a unique chip ID and the chip's public key. The certificate may be signed by the chip vendor's private key. An optional second certificate (222 of FIG. 2) may claim the chip vendor ID and the chip vendor's public key. The second certificate may be signed by a certificate authority's private key. One of ordinary skill in the art would understand that a chip vendor requires only on such certificate for several years and the certificate may be sufficient to last the IoT chips operational lifetime. Shared and public content may include the public key of the chip vendor and may also include public keys of major chip vendors and certificate authorities.

Private content, such as private content 280 of FIG. 2, may include a private key for the IoT chip and a secret key for firmware signature verification. The private key for the IoT chip may be saved to write only OTP registers and accessed only by a dedicated circuit that applies the private key to a given data block. In this embodiment, the registers cannot be read by the CPU or any AXI master outside the dedicated circuit. In another embodiment, the OTP registers may be read by ROM code or certified firmware in secure mode for ARM CPUs with TrustZone. In this embodiment, JTAG in secure mode may be disabled. In still another embodiment, only ROM code or secure bootloader code saved in internal flash may access the private key from a readable OTP register and may execute a public/private key algorithm in a dedicated internal SRAM.

The secret key for firmware signature verification that is part of the private content may include a public key or a secret symmetric key from the firmware author. In this embodiment, the firmware author may be an entity other than the chip vendor. The implementation, storage, and access of the secret key may correspond to the implementation, storage, and access of the private key above.

The application of the above embedded certificate and authorization protocols may be implemented for a Bluetooth® lock with strong security. The Bluetooth lock may use a fixed PIN and have a built-in certificate. The Bluetooth lock may not have an input/output/display device. A unique ID may be printed on the lock itself. The lock may be controlled by a handset with a Bluetooth-compliant chip that does not support a built-in certificate. The Bluetooth® handset may run an application (“app”) that is provided by the lock manufacturer. It is assumed for this implementation that neither the lock nor the app is compromised, though the app's running environment may not be secure. That is, the app's data may be read and viewed by other devices.

The goals of the lock are to prevent potential eavesdroppers from opening the lock, while allowing multiple authorized users to open the lock. An unauthorized user running the same app on an authorized user's handset should not be able to open the lock. The lock should be easy to use and protect a naïve user from a malicious lock.

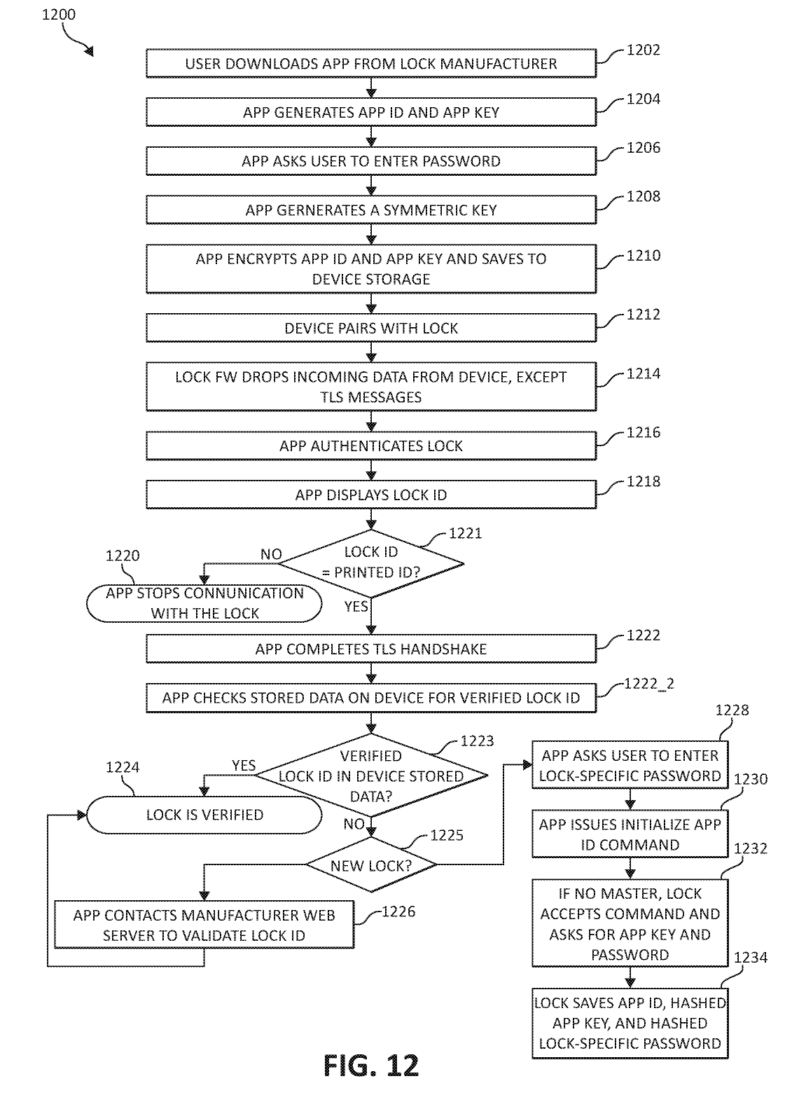

FIG. 12 illustrates the process 1200 for the Bluetooth lock with strong security with the goals and parameters above. First, the user may download the app from the lock manufacturer in step 1202. When the app is first run, it generates an app ID with high entropy, and an app key (also with high entropy) in step 1204. The app may then ask the user to enter a password in step 1206. The user-entered password may be called the app password and have low entropy. Using the app password's hash value, the app may generate a symmetric key in step 1208. The app may encrypt the app ID and the app key with the symmetric key and save the encrypted result to device storage in step 1210.

The handset's device storage may be read by other devices, so the app ID and the app key may be encrypted using a secret not stored on the handset in one embodiment. As the user was required to enter the app password to run the app, the app does not know if the entered password is correct or incorrect. Therefore, the low-entropy password may protect secret data because a brute-force attack must be verified with a real and time-consuming method. Such a method is easily identified by the lock.

The Bluetooth handset may pair with the lock in step 1212 with weak authentication (due to the fixed PIN). The lock then drops any incoming data from the handset except TLS messages in step 1214 so that authentication is not interrupted by spurious data. The app may then follow a TLS protocol similar to that described above in FIGS. 4-9 to authenticate the lock using the locks built-in certificate in step 1216. In one embodiment, the app corresponds to the counter party and the lock corresponds to the IoT device (or IoT chip) of FIGS. 4-9.

After the lock verifies the lock's certificate, the app may display the lock ID in the certificate for the user in step 1218 for the user to verify if it is identical to the ID printed on the lock. If the lock ID in the certificate is not identical to the ID printed on the lock in step 1221, the app may discontinue communication with the lock in step 1220. If the lock ID in the certificate is identify to the ID printed on the lock in step 1221, the app may complete the TLS handshake with an encrypted channel to the lock in step 1222 and check stored data on the IoT device for a verified lock ID in step 1222_2.

At this point the lock may accept only three commands from the app: initialize, introduction_followup, and authenticate. This is because the lock has been authenticated to the app, but the app has not been authenticated to the lock.

The app checks that the lock ID has been verified by reading the stored data on the handset in step 1223. If the lock ID has been verified, the lock is identified as such as the lock may receive additional commands from the app in step 1224. If the stored data on the handset does not indicate that the lock is verified, it is determined if the lock is a new lock in step 1225. If the lock is not new, the app may contact the manufacturer's web server or online database to validate the lock ID in step 1226. If the lock is a new lock in step 1225 the app may ask the user to enter a lock-specific password in step 1228 and then issue an initialization command in step 1230. The initialization command may serve to make the app the initial master of the lock. If there is no existing master, the lock may accept the command and ask the app for its app key and password in step 1232. The lock may save the app ID, the hashed app key, and the hashed lock-specific password to a memory location in step 1234.

The embodiments described herein may be used with various wireless communication protocols and paradigms including, but not limited to: Bluetooth®, Bluetooth Low Energy (BLE), Zigbee®, and WiFi. The embodiments of the various steps and processes described herein are not tied to a particular communication protocol and can be used as well with other protocols, as would be appreciated by one of ordinary skill in the art having the benefit of this disclosure.

In the above description, numerous details are set forth. It will be apparent, however, to one of ordinary skill in the art having the benefit of this disclosure, that embodiments of the present invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “encrypting,” “decrypting,” “storing,” “providing,” “deriving,” “obtaining,” “receiving,” “authenticating,” “deleting,” “executing,” “requesting,” “communicating,” “initializing,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Specific commands ore messages referenced in relation to the above-described protocol are intended to be illustrative only. One of ordinary skill in the art would understand that commands of different specific wording but similar function may be used and still fall within the ambit of the above description.

Embodiments described herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store one or more sets of instructions. The term “computer-readable medium” shall also be taken to include any medium that is capable of storing, encoding or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The algorithms and displays presented or referenced herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details such as examples of specific systems, components, methods and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth above are merely exemplary. Particular implementations may vary from these exemplary details and still be contemplated to be within the scope of the present invention.

It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. An Internet-of-Things (IoT) device for connecting to a counter party, the IoT device configured to execute instruction to:
establish a connection between the IoT device and the counter party;
if an identification (ID) of the IoT device is stored in an access control list (ACL) of the counter party, begin an authentication protocol; and
if the IoT device ID is not stored in the ACL of the counter party, begin an initialization protocol, wherein the initialization protocol establishes a secure connection between the IoT device and the counter party with which to begin the authentication protocol.

2. The IoT device of claim 1, wherein the initialization protocol comprises comparing the IoT device ID with an online database associated with the counter party.

3. The IoT device of claim 1, wherein the initialization protocol comprises:
if an ACL of the IoT device is not empty, comparing a first hash of a nonce from the IoT device to a second hash of a nonce from the counter party, and if they are the same, continuing the initialization protocol;
if the ACL of the IoT device is empty:
if the counter party sent a certificate to the IoT device, validating the certificate with the IoT device and saving a counter party ID to the IoT device ACL, and
if the counter party did not send a certificate to the IoT device, saving the counter party ID to the IoT device ACL after a secret initialization request from the IoT device and a secret initialization request response from the counter party; and
changing communication between the counter party and the IoT device to be based on a shared secret.

4. The IoT device of claim 1, wherein the authorization protocol comprises:
if a counter party ID is in an ACL of the IoT device:
if the counter party sends a certificate in an authorization request, validating the certificate with the IoT device, and
if the counter party does not send a certificate in the authorization request, validating a hash value from the counter party and the IoT device, and
authenticating communication between the counter party and the IoT device; and
if the counter party ID is not in the ACL of the IoT device, rejecting authorization of the counter party.

5. The IoT device of claim 4, wherein the validating the certificate with the IoT device comprises:
sending a nonce from the IoT device to the counter party;
calculating a hash value of the nonce by the counter party and by the IoT device;
comparing the hash value from the counter party and the hash value from the IoT device; and
if the hash value from the counter party and the hash value from the IoT device are the same, authenticating communication between the IoT device and the counter party.

6. The IoT device of claim 1, wherein establishing a connection between the IoT device and the counter party comprises:
sending and receiving a plurality of messages to and from the IoT device and the counter party; and
if the plurality of messages are received within an allowable window of time, establishing a communication link between the IoT device and the counter party.

7. A device comprising a memory, the memory storing an embedded certificate comprising:
shared public content comprising:
a unique chip identification (ID) and a chip public key,
a first chip vendor ID and a first chip vendor public key, and
a first storage location for a first hash block and an first encrypted result;
unshared public content comprising the first chip vendor public key; and
private content.

8. The device of claim 7, the shared public content further comprising:
a second chip vendor ID and a second vendor public key;
a certificate authority ID and a certificate authority public key; and
a second storage location for a second hash block and an second encrypted result.

9. The device of claim 7, the unshared public content further comprising at least as second chip vendor public key.

10. The device of claim 7, the unshared public content further comprising at least one certificate authority public key.

11. The device of claim 7, wherein the private content comprises a private key for a IoT integrated circuit.

12. The device of claim 7, wherein the embedded certificate is saved in on-time-programmable (OTP) registers.

13. The device of claim 7, wherein the embedded certificate is saved in secure flash memory.

14. The device of claim 7, wherein the embedded certificate is verified by:
calculating a hash value of the unique chip ID and the chip public key, the hash value signed by the first chip vendor's public key;
generating a decrypted hash value from the hash value and the first chip vendor's public key; and
if the hash value and the decrypted hash values are identical, verifying the embedded certificate.

15. A method for receiving an embedded certificate by an Internet-of-Things (IoT) device from a device manufacturer's online database, the method comprising:
establishing a connection between the IoT device and the device manufacturer's server;
authenticating the device manufacturer's server;
creating an encrypted connection between the IoT device and the device manufacturer's server;
generating test code by the device manufacturer's online database and sending the test code to the IoT device;
comparing a plurality firmware code words from the IoT device after the IoT device executes the test code to expected code words of device firmware; and
if the firmware code words from the IoT device match the expected code words of device firmware, issuing the embedded certificate to the IoT device from the device manufacturer's server.

16. The method for receiving an embedded certificate by an Internet-of-Things (IoT) device from a device manufacturer's server of claim 15, wherein generating test code also comprises adding a dead line for the IoT device to run the test code and response to the device manufacturer's server.

17. The method for receiving an embedded certificate by an Internet-of-Things (IoT) device from a device manufacturer's server of claim 15, wherein the embedded certificate is saved in secure flash memory of the IoT device.

18. The method for receiving an embedded certificate by an Internet-of-Things (IoT) device from a device manufacturer's server of claim 15, wherein, after the encrypted connection between the IoT device and the device manufacturer's server is created, the IoT device sends a device model and firmware version number to the device manufacturer's server.

19. The method for receiving an embedded certificate by an Internet-of-Things (IoT) device from a device manufacturer's server of claim 18, wherein the test code is derived from the device model and firmware version number from the IoT device.
